(19) United States
(12) Patent Application Publication
(10) Pub. No.: US 2026/0318123 A1
(43) Pub. Date: Oct. 15, 2026

(54) LATCH DEVICE FOR VEHICLE DOOR

(71) Applicant: Nissan Motor Co., Ltd., Yokohama-shi, Kanagawa (JP)

(72) Inventors: Kenjirou HAYASHI, Kanagawa (JP); Takayuki OBATA, Kanagawa (JP); Yusuke SASAKI, Kanagawa (JP); Kaito NAGANO, Kanagawa (JP)

(21) Appl. No.: 19/104,718

(22) PCT Filed: Aug. 22, 2022
(86) PCT No.: PCT/JP2022/031510

§ 371 Date: Feb. 19, 2025

(51) Int. Cl. E05B 81/20; E05B 81/56; E05B 81/66

(52) U.S. Cl. CPC E05B 81/20; E05B 81/56; E05B 81/66

(57) ABSTRACT

A vehicle door latch device includes a catch, a sector gear, a cinch lever, a pawl and a release lever. The catch engages a striker so that the catch can rotate in a latch direction toward a fully-latched position. The sector gear is rotated by an actuator. The cinch lever is coupled to the sector gear and contacts a contact portion of the catch to rotate the catch in the latch direction. The pawl restricts rotation of the catch in a release direction. The release lever releases the pawl upon contact with the sector gear. One of the sector gear and the cinch lever has a second groove. The second groove is configured such that when the catch and the cinch lever are in an irregular position, the sector gear comes into contact with the release lever and can release the restriction of the catch by the pawl.

### CROSS-REFERENCE TO RELATED APPLICATIONS

This application is a U.S. national stage application of International Application No. PCT/JP 2022/031510, filed on Aug. 22, 2022.

### BACKGROUND

### Technical Field

The present invention relates to a latch device for a vehicle door.

### Background Information

A latch device for a vehicle door is known, which includes a power cinching mechanism that displaces a latch from a half-latched position to a fully-latched position (U.S. Patent Application Publication No. 2021/0301562A). The latch device described in this document is attached to the back door of a vehicle and has a catch, a cinch lever, and a pawl. The latch device engages/releases the catch and a striker provided on the body side, thereby displacing the back door between the half-latched position and the fully-latched position.

### SUMMARY

In the latch device for a vehicle door including the above conventional power cinching mechanism, the cinch lever operated by an actuator rotates the catch in the latch direction, thereby displacing the catch from the half-latched position to the fully-latched position, but the cinch lever is located behind the catch in the latch direction.

Unfortunately, however, the inventors have confirmed that when the driver operates to close the door and the door is in the half-latched position, if the driver operates to open the door in the opposite direction and to return the catch to the state before the half-latch, the cinch lever, which is located behind the catch in the half-latched position, will come to the front side of the catch. When such an irregular state occurs, a problem may arise in that the cinch lever is mechanically locked and the return operation cannot be performed.

A problem to be solved by the present invention is to provide a latch device for a vehicle door that, even if the positional relationship between the catch and the cinch lever becomes an irregular state, can recover the normal positional relationship.

The present invention solves the above problem through providing one of a drive element, which is rotated by an actuator, and a cinch lever with a rotation restricting section that restricts a rotation range of the drive element depending on a rotation position of the cinch lever and configuring the rotation restricting section such that when a catch is in a position between a fully-latched position and an unlatched position and the cinch lever is located forward of a contact portion of the catch in the latch direction of the catch, the drive element comes into contact with a release member to allow the release member to rotate in a counter-restriction direction.

According to the present invention, even if the positional relationship between the catch and the cinch lever becomes an irregular state, the drive element comes into contact with the release member to allow the release member to rotate in the counter-restriction direction, so that the catch can rotate in the release direction to return to the unlatched position. This allows the catch and the cinch lever to recover the normal positional relationship.

### BRIEF DESCRIPTION OF DRAWINGS

Referring now to the attached drawings which form a part of this original disclosure, illustrative embodiments are shown.

FIG. 1 is a perspective view of a latch device for a vehicle door according to one embodiment of the present disclosure.

FIG. 2A is a front view of a catch and a pawl of the latch device of FIG. 1 for illustrating an unlatched state of the catch and the pawl (unlatched position P1 of the catch). FIG. 2B is a front view of the catch and the pawl of FIG. 1 for illustrating a half-latched state of the catch and the pawl (half-latched position P2 of the catch).

FIG. 2C is a front view of the catch and the pawl of FIG. 1 for illustrating a fully-latched state of the catch and the pawl (fully-latched position P3 of the catch).

FIG. 3A is a front view of a sector gear and a cinch lever of the latch device of FIG. 1 for illustrating the unlatched state or half-latched state of the sector gear and the cinch lever.

FIG. 3B is a front view of the sector gear and the cinch lever of FIG. 1 for illustrating the fully-latched state of the sector gear and the cinch lever (before the sector gear returns to the neutral position).

FIG. 3C is a front view of the sector gear and the cinch lever of FIG. 1 for illustrating the fully-latched state of the sector gear and the cinch lever (after the sector gear returns to the neutral position).

FIG. 3D is a front view of the sector gear and the cinch lever of FIG. 1 for illustrating a release operation of the sector gear and the cinch lever.

FIG. 3E is a cross-sectional view of the sector gear and the cinch lever of FIG. 1 taken along section line IIIE-IIIE OF FIG. 3A.

FIG. 4 is a set of perspective views of the latch device for illustrating the operation of the latch device when closing the door.

FIG. 5 is a set of perspective views of the latch device for illustrating the operation of the latch device when opening the door.

FIG. 6 is a set of perspective views of the latch device for explaining the cause of an irregular positional relationship between the catch and the cinch lever.

FIG. 7 is an enlarged front view of the sector gear, the cinch lever, and the catch illustrated in the right diagram of FIG. 6.

FIG. 8 is a front view of the sector gear and the cinch lever for illustrating the operation of returning from the irregular positional relationship illustrated in FIG. 7.

FIG. 9A is a front view of the sector gear and the cinch lever for illustrating the sector gear and the cinch lever of another embodiment of the latch device for a vehicle door according to the present disclosure.

FIG. 9B is a cross-sectional view of the sector gear and the cinch lever taken along section line IXB-IXB of FIG. 9A.

### DETAILED DESCRIPTION OF EMBODIMENTS

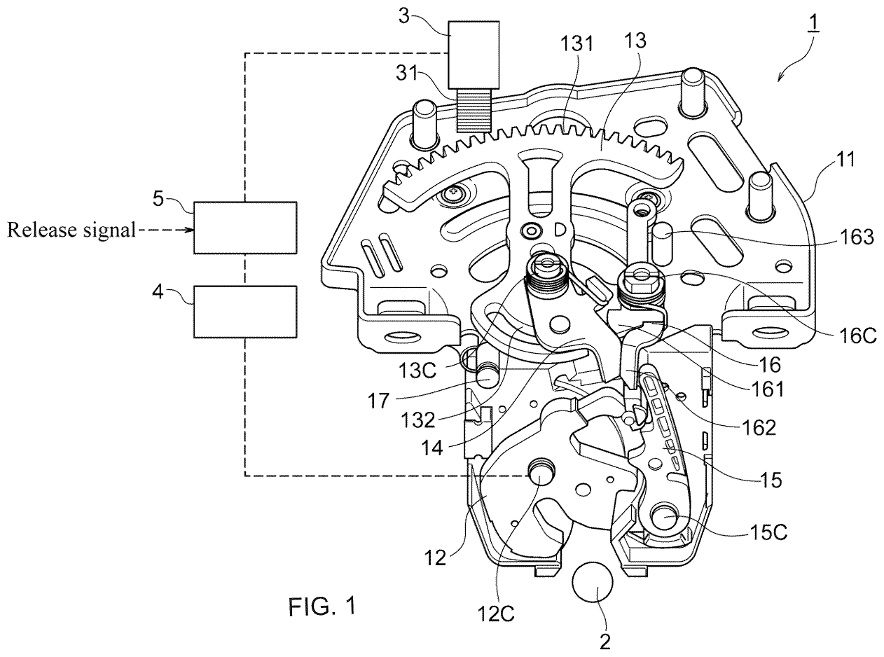

Hereinafter, one or more embodiments of the present invention will be described with reference to the drawings. FIG. 1 is a perspective view illustrating an embodiment of a latch device for a vehicle door according to the present invention. Latch device 1 for a vehicle door (also simply referred to as the latch device 1, hereinafter) of the present embodiment is applied to various vehicle doors such as back doors, side doors (front side doors, rear side doors), and trunk lids. When the vehicle door is closed, it is firmly closed to keep a tightly closed state in the vehicle interior or in the trunk, while when the vehicle door is opened, it is half-shut to allow the opening operation to be easily performed afterward.

The latch device 1 for a vehicle door of the present embodiment, which is attached to the vehicle door side, engages with a striker 2 to put the vehicle door into a closed state and is released from the striker 2 to put the vehicle door into an opened state. The striker 2 is fixed to the body side of the vehicle, for example, the back door opening portion, the side door opening portion, the trunk opening portion, etc.

The latch device 1 for a vehicle door of the present embodiment includes a base plate 11, to which a catch 12, a sector gear 13, a cinch lever 14, a pawl 15, and a release lever 16 are each rotatably attached. The base plate 11 to which these elements are attached is then fixed to a vehicle door (not illustrated), such as a back door, using bolts or the like. The striker 2 is configured by bending a solid round bar of steel material, and is fixed to the vehicle body side. Only its cross section is illustrated in FIG. 1. The sector gear 13 is an example of the drive element according to the present invention, and the pawl 15 and release lever 16 are an example of the release member according to the present invention.

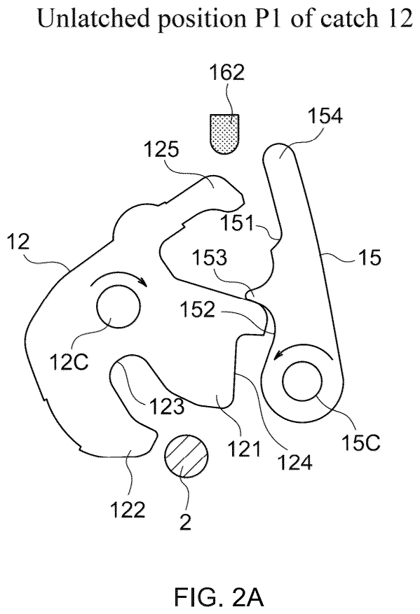

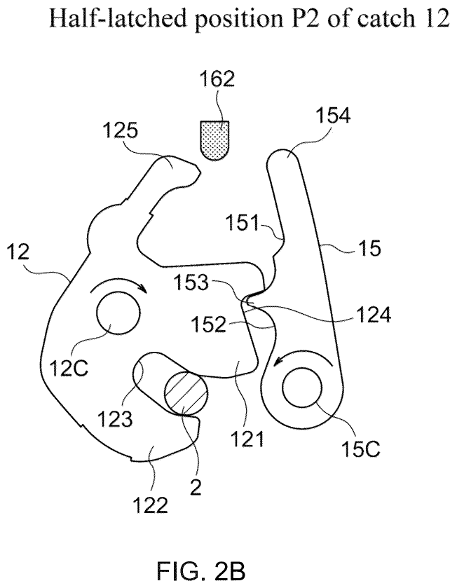

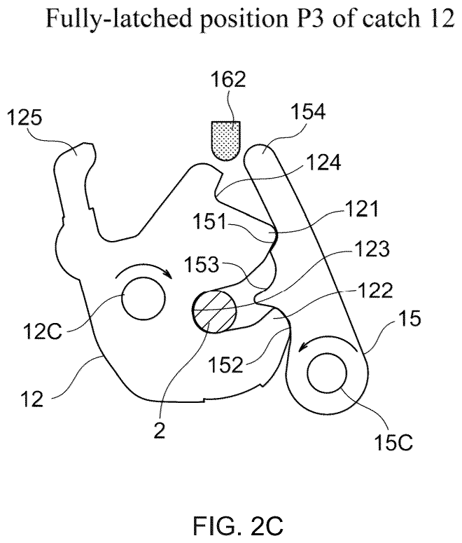

The catch 12 is attached to the base plate 11 so as to be rotatable about a rotation shaft 12C, and is elastically biased in a release direction against the base plate 11 by a coil spring or the like (not illustrated). The rotational position of the catch 12 will now be described with reference to FIGS. 2A to 2C. FIG. 2A is a front view illustrating an unlatched state of the catch 12 and pawl 15 (unlatched position P1 of the catch 12), FIG. 2B is a front view illustrating a half-latched state of the catch 12 and pawl 15 (half-latched position P2 of the catch 12), and FIG. 2C is a front view illustrating a fully-latched state of the catch 12 and pawl 15 (fully-latched position P3 of the catch 12).

The catch 12 rotates between the unlatched position P1 in which the striker 2 is released as illustrated in FIG. 2A and the fully-latched position P3 in which the striker 2 is fully gripped as illustrated in FIG. 2C, and passes through the half-latched position P2 in which the striker 2 is half-gripped as illustrated in FIG. 2B. In the rotation directions of the catch 12, the rotation direction toward the fully-latched position P3 is called the latch direction, and the rotation direction toward the unlatched position P1 is called the release direction. Referring to FIG. 1 and FIGS. 2A to 2C, the direction in which the catch 12 rotates clockwise is the release direction, and the direction in which the catch 12 rotates counterclockwise is the latch direction. The terms latch direction and release direction are used not only to refer to the rotation direction of the catch 12, but also to the rotation directions of the sector gear 13, cinch lever 14, pawl 15, and release lever 16 that constitute the latch device 1. That is, upon rotation of these elements, the rotation direction when the latch device 1 operates to be latched is called the latch direction, and the rotation direction when the latch device 1 operates to be released is called the release direction.

The catch 12 is elastically biased in the release direction, that is, the clockwise direction illustrated in FIG. 1, but the rotation in the release direction is restricted at the unlatched position P1 illustrated in FIG. 2A by a stopper (not illustrated). That is, the catch 12 is configured so as not rotate further in the release direction (clockwise direction) than the unlatched position P1 illustrated in FIG. 2A. In the state in which the vehicle door is open, the catch 12 waits for engagement with the striker 2 at the unlatched position P1 illustrated in FIG. 2A.

The catch 12 is composed of a flat metal material or synthetic resin material and, as illustrated in FIG. 2C, includes a first convex portion 121 that engages with a first concave portion 151 of the pawl 15 at the fully-latched position P3, a second convex portion 122 that engages with a second concave portion 152 of the pawl 15, and a notch portion 123 with which the striker 2 engages. When the catch 12 is located at the fully-latched position P3 as illustrated in FIG. 2C, the first convex portion 121 of the catch 12 engages with the first concave portion 151 of the pawl 15, and the second convex portion 122 of the catch 12 engages with the second concave portion 152 of the pawl 15. This allows the catch 12 to be restrained at the fully-latched position P3 illustrated in FIG. 2C against the elastic bias acting in the release direction.

In addition, as illustrated in FIG. 2B, the catch 12 includes a first concave portion 124 that engages with a first convex portion 153 of the pawl 15 at the half-latched position P2. As illustrated in FIG. 2B, when the catch 12 is located at the half-latched position P2, the first convex portion 153 of the pawl 15 engages with the first concave portion 124 of the catch 12. This allows the catch 12 to be temporarily restrained at the half-latched position P2 illustrated in FIG. 2B against the elastic bias acting in the release direction. The catch 12 also includes a contact portion 125 that comes into contact with the cinch lever 14.

Referring again to FIG. 1, the sector gear 13 and the cinch lever 14 are attached to the base plate 11 by the same rotation shaft 13C. The sector gear 13, which is a gear formed in a sector shape, is connected to an actuator 3 so that a teeth portion 131 of the sector gear 13 meshes with a teeth portion 31 of the actuator 3. The sector gear 13 of the present embodiment corresponds to the drive element according to the present invention, but the drive element according to the present invention may be any member that is rotated by the actuator 3 and acts on the cinch lever 14 and release lever 16 as described later, and is not limited to only the sector gear 13.

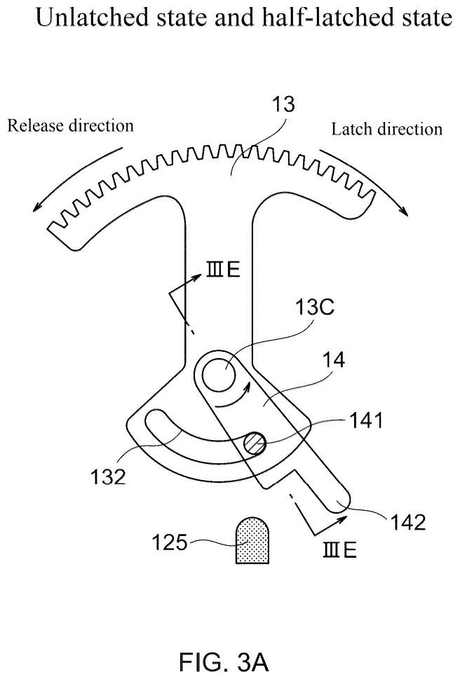

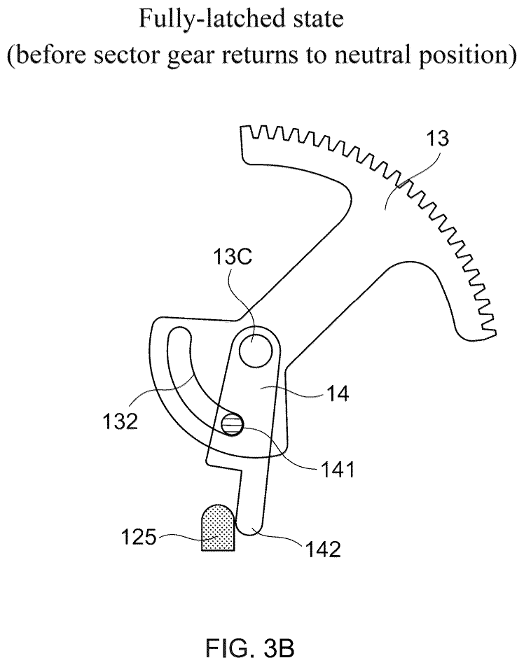

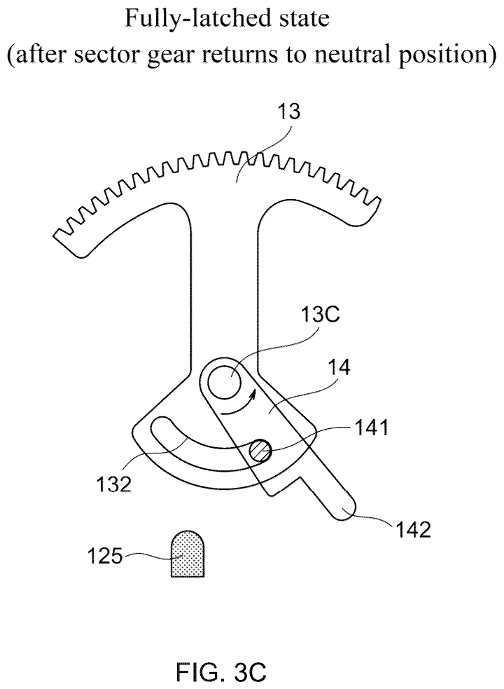

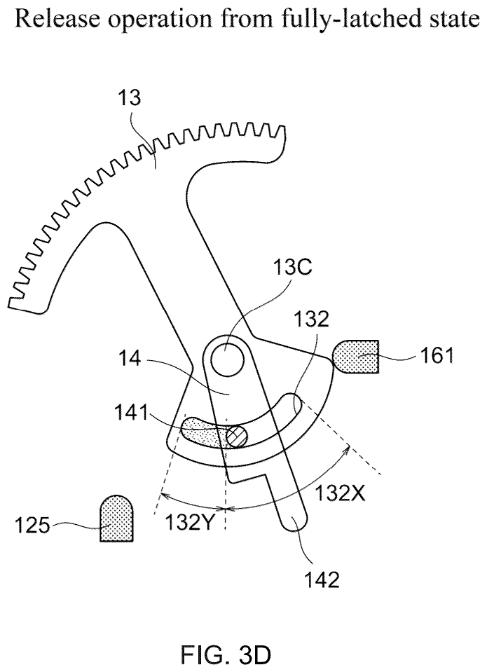

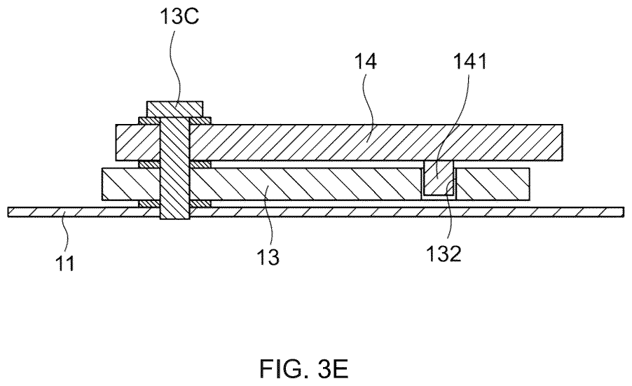

The sector gear 13 is also formed with a curved, elongated groove 132 through which a pin 141 of the cinch lever 14 passes (see also the cross-sectional view of FIG. 3E). The position illustrated in FIG. 1 is a neutral position, and the sector gear 13 is provided so as to be rotatable in both clockwise and counterclockwise directions. In FIG. 1, the direction in which the sector gear 13 rotates clockwise is the latch direction, and the direction in which the sector gear 13 rotates counterclockwise is the release direction. The groove 132 and pin 141 of the present embodiment are an example of the rotation restricting section according to the present invention.

FIGS. 3A to 3E are front views each illustrating the relationship between the sector gear 13 and the cinch lever 14. FIG. 3A illustrates the unlatched state or half-latched state, FIG. 3B illustrates the fully-latched state before the sector gear 13 returns to the neutral position, FIG. 3C illustrates the fully-latched state after the sector gear 13 returns to the neutral position, FIG. 3D illustrates the release operation of the sector gear 13 and cinch lever 14, and FIG. 3E is a cross-sectional view taken along line IIIE-IIIE of FIG. 3A.

As illustrated in FIG. 3A, the cinch lever 14 is elastically biased in the release direction relative to the sector gear 13, that is, the counterclockwise direction in the figure. The cinch lever 14 also has the pin 141 that passes through the groove 132 of the sector gear 13, and in the state in which no other load is acting on the cinch lever 14, the cinch lever 14 is elastically biased in the release direction and stops at a position at which the pin 141 abuts against the right end of the groove 132, thus restricting further rotation in the release direction.

As will be described in detail later, when the sector gear 13 rotates clockwise (in the latch direction) from the neutral position illustrated in FIG. 3A, the cinch lever 14 also rotates clockwise (in the latch direction) about the rotation shaft 13C as the sector gear 13 rotates because the cinch lever 14 provided on the same rotation shaft 13C as the sector gear 13 abuts against the right end of the groove 132 as illustrated in FIG. 3B. This allows a contact portion 142 of the cinch lever 14 to come into contact with the contact portion 125 of the catch 12, thus rotating the catch 12 from the unlatched position P1 illustrated in FIG. 2A or the half-latched position P2 to the fully-latched position P3 illustrated in FIG. 2C.

On the other hand, as illustrated in FIG. 3C, when the catch 12 rotates to the fully-latched position P3, the first concave portion 151 of the pawl 15 engages with the first convex portion 121 of the catch 12, and the second concave portion 152 of the pawl 15 engages with the second convex portion 122 of the catch 12, as illustrated in FIG. 2C, and the catch 12 is prevented from rotating in the release direction in the state of gripping the striker in the notch portion 123. Accordingly, the sector gear 13 rotates counterclockwise to return to the neutral position as illustrated in FIG. 3C, and the cinch lever 14 also rotates counterclockwise due to the elastic bias as the sector gear 13 rotates counterclockwise.

Upon release from the fully-latched state illustrated in FIG. 3C, the sector gear 13 rotates counterclockwise from the neutral position as illustrated in FIG. 3D, and comes into contact with a first contact portion 161 of the release lever 16 to push it. As will be described in detail later, this releases the rotation restriction on the catch 12 via the release lever 16 and the pawl 15, and the striker 2 is released. When this sector gear 13 rotates counterclockwise from the neutral position, the cinch lever 14, which is elastically biased counterclockwise relative to the sector gear 13, also rotates counterclockwise. Unfortunately, however, because the space for the layout of the components of the latch device 1 is limited, when the cinch lever 14 rotates counterclockwise, there may not be enough space to ensure that it does not interfere with other components.

In the latch device 1 of the present embodiment, therefore, the groove 132 of the sector gear 13 is formed in an elongated hole shape, so that when the sector gear 13 rotates counterclockwise from the neutral position illustrated in FIG. 1, even if the tip portion of the cinch lever 14 abuts against the base plate 11 or the like, the cinch lever 14 remains stopped at that position and the sector gear 13 can rotate further counterclockwise. FIG. 3D illustrates a rotation limit (counterclockwise end portion) for the sector gear 13 rotated counterclockwise to release the fully-latched state of the catch 12, and in this state the sector gear 13 comes into contact with the first contact portion 161 of the release lever 16 to push it. The range of the groove 132 illustrated in the figure, indicated by 132X, is the range of the groove required for the relative rotation of the sector gear 13 and the cinch lever 14 during the release operation of the latch device 1, and is also called a first groove 132X. In the latch device 1 of the present embodiment, the elongated hole-shaped groove 132 is not only the first groove 132X, but is expanded to the range indicated by 132Y, the details of which will be described later. This range is also called a second groove 132Y.

Referring again to FIG. 1, the pawl 15 is attached to the base plate 11 so as to be rotatable about the rotation shaft 15C, and is elastically biased by a coil spring or the like (not illustrated) in a restriction direction in which the rotation of the catch 12 in the release direction relative to the base plate 11 is restricted. That is, in the example illustrated in FIG. 1 and FIGS. 2A to 2C, the pawl 15 is elastically biased in the counterclockwise direction. The pawl 15 is composed of a flat metal material or a synthetic resin material, and as illustrated in FIG. 2C, includes the first concave portion 151 that engages with the first convex portion 121 of the catch 12 at the fully-latched position P3, and the second concave portion 152 that engages with the second convex portion 122 of the catch 12 at the fully-latched position P3. In addition, as illustrated in FIG. 2B, the pawl 15 includes the first convex portion 153 that engages with the first concave portion 124 of the catch 12 at the half-latched position P2. Furthermore, the pawl 15 also includes a contact portion 154 that comes into contact with the release lever 16.

As illustrated in FIG. 1, the release lever 16 is attached to the base plate 11 so as to be rotatable about the rotation shaft 16C, and is elastically biased by a coil spring in a direction that allows the pawl 15 to rotate counterclockwise (restriction direction for the catch 12) relative to the base plate 11. That is, in the example illustrated in FIG. 1, the release lever 16 is elastically biased in the clockwise direction. The release lever 16 is composed of a flat metal material or synthetic resin material, and includes the first contact portion 161 that comes into contact with the sector gear 13 during the release operation of the latch device 1, and a second contact portion 162 that comes into contact with the contact portion 154 of the pawl 15.

The clockwise rotation of the release lever 16 caused by the elastic bias is restricted by a stopper pin 163 provided on the base plate 11, so that it cannot rotate any further in the clockwise direction. The second contact portion 162 in this rotation limit state is located at a position on the left side of the pawl 15 (forward of the pawl 15 in the direction of elastic bias) as in the fully-latched state illustrated in FIG. 2C. That is, it is located so as not to interfere with the operation of the pawl 15 rotating counterclockwise to restrain the catch 12 at the fully-latched position P3. When the sector gear 13 pushes the first contact portion 161, the release lever 16 rotates counterclockwise against the elastic bias, and the second contact portion 162 illustrated in FIG. 2C pushes the contact portion 154 of the pawl 15 to the right in the figure, so that the restraint of the catch 12 by the pawl 15 is released.

In the present embodiment, the release member that restrains or releases the catch 12 at the fully-latched position P3 is composed of two members, the pawl 15 and the release lever 16, but the release member according to the present invention may be composed of one member or three or more members.

The latch device 1 for a vehicle door of the present embodiment further includes a sensor 4 that detects the half-latched position P2 of the catch 12, and a controller 5 that drives and controls the actuator 3 based on the detection signal from the sensor 4 and the release signal from a door open switch.

The type of sensor 4 is not particularly limited, provided that it can detect that the catch 12 is in the half-latched position P2, and various sensors such as a proximity switch, a rotary encoder, and a limit switch can be used. The sensor 4 notifies the driver that the catch 12 is in the half-latched position P2, and warns the driver not to drive with the door half-shut.

A door open switch (not illustrated) is provided on the vehicle, for example, near the door hook or around the instrument panel, and when the driver presses the door open switch, a release signal from the door open switch is input to the controller 5. This allows the controller 5 to operate to: drive and control the actuator 3; drive the sector gear 13 to rotate in the release direction (counterclockwise direction) to rotate the release lever 16 counterclockwise; release the restraint of the catch 12 by the pawl 15; and rotate the catch 12 from the fully-latched position P3 to the half-latched position P2 or the unlatched position P1.

On the other hand, in the case of closing the door, when the door is closed to the half-shut state automatically or manually by the driver, the sensor 4 detects that the catch 12 is in the half-latched position P2, so the controller 5 operates to: drive and control the actuator 3; drive the sector gear 13 to rotate in the latch direction (clockwise direction) to rotate the cinch lever 14 in the latch direction; and rotate the catch 12 from the half-latched position P2 to the fully-latched position P3.

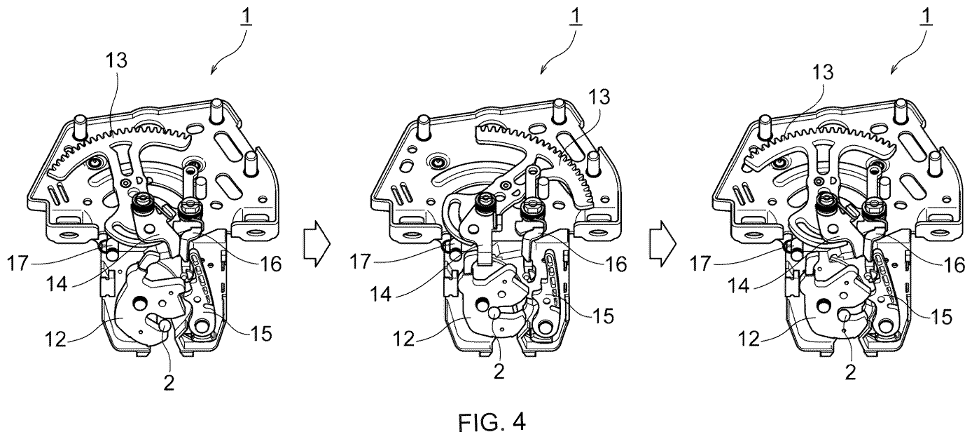

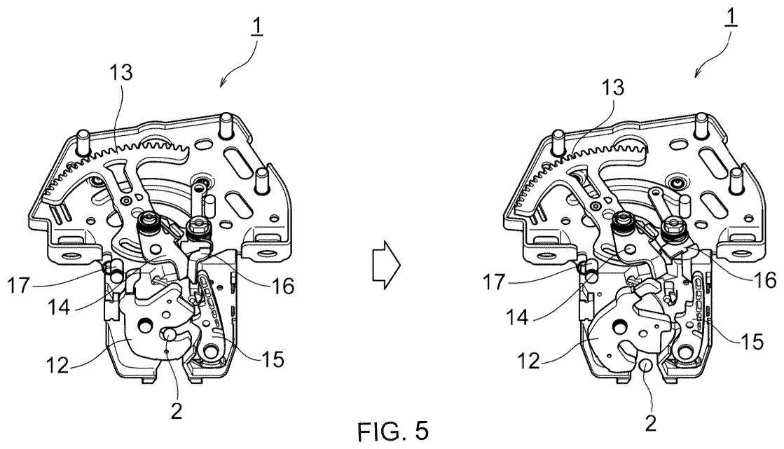

The description will then be directed to the operation when closing a door provided with the vehicle door latch device 1 of the present embodiment and the operation when opening the door. FIG. 4 is a perspective view illustrating the operation when closing the door, and FIG. 5 is a perspective view illustrating the operation when opening the door.

When closing the door, the door is closed automatically or manually by the driver from the open state to the half-shut state. In this half-shut state, the catch 12 rotates to the half-latched position P2, and the striker 2 engages near the entrance of the notch portion 123 as illustrated in FIG. 2B. This half-latched state is illustrated in the left diagram of FIG. 4.

When the catch 12 rotates from the unlatched position P1 to the half-latched position P2, the sensor 4 detects that the catch 12 is in the half-latched position P2, so the controller 5 operates to: drive and control the actuator 3; drive the sector gear 13 to rotate in the latch direction (clockwise direction) to rotate the cinch lever 14 in the latch direction; and rotate the catch 12 from the half-latched position P2 to the fully-latched position P3. This state is illustrated in the center diagram of FIG. 4. This results in the fully-latched state, and the detection signal from the sensor 4 for the half-latched position P2 of the catch 12 stops, so the half-shut warning light displayed on the instrument panel or the like turns off.

When the catch 12 rotates to the fully-latched position P3, as illustrated in FIG. 2C, the first concave portion 151 of the pawl 15 engages with the first convex portion 121 of the catch 12, and the second concave portion 152 of the pawl 15 engages with the second convex portion 122 of the catch 12, so the catch 12 is prevented from rotating in the release direction in the state of gripping the striker in the notch portion 123. The sector gear 13 therefore rotates counterclockwise to return to the neutral position as illustrated in the right diagram of FIG. 4, and the cinch lever 14 also rotates counterclockwise due to the elastic bias as the sector gear 13 rotates counterclockwise. Thus, the door closing operation is completed.

On the other hand, when opening the door, the driver presses the door open switch provided on the vehicle. When the door open switch is pressed, a release signal from the door open switch is input to the controller 5, which drives and controls the actuator 3 to rotate the sector gear 13 in the neutral position in the release direction (counterclockwise direction). This state is illustrated in the left diagram of FIG. 5.

When the sector gear 13 rotates counterclockwise as illustrated in the diagram, it comes into contact with the first contact portion 161 of the release lever 16. This allows the release lever 16 to rotate counterclockwise as illustrated in the diagram, and the second contact portion 162 at one end of the release lever 16 comes into contact with the contact portion 154 of the pawl 15 and pushes it. This allows the pawl 15 to rotate clockwise as illustrated in the diagram. This state is illustrated in the right diagram of FIG. 5. When the pawl 15 rotates in the clockwise direction, engagement between the first concave portion 151 of the pawl 15 and the first convex portion 121 of the catch 12 and engagement between the second concave portion 152 of the pawl 15 and the second convex portion 122 of the catch 12 are released; therefore, restraint of the catch 12 whose rotation in the release direction is restricted is released, the catch 12 rotates in the release direction due to elastic bias, and the catch 12 rotates from the fully-latched position P3 to the half-latched position P2. After this, the door is opened automatically or manually by the driver.

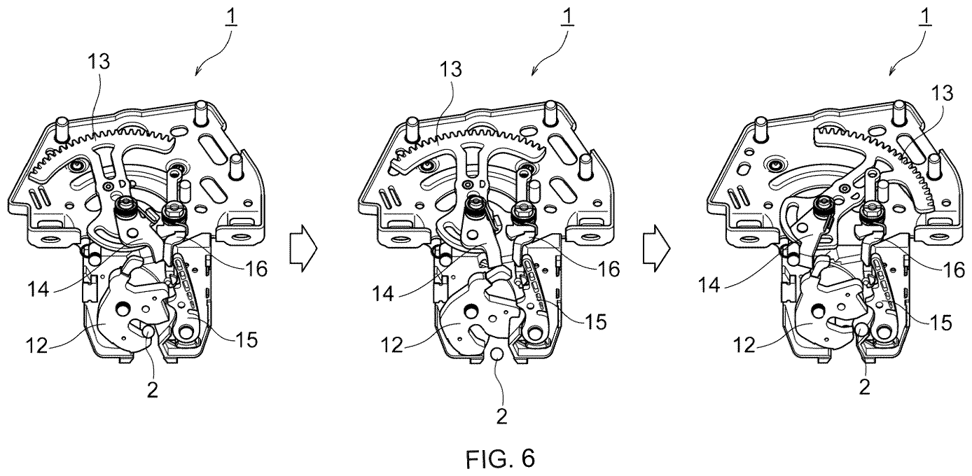

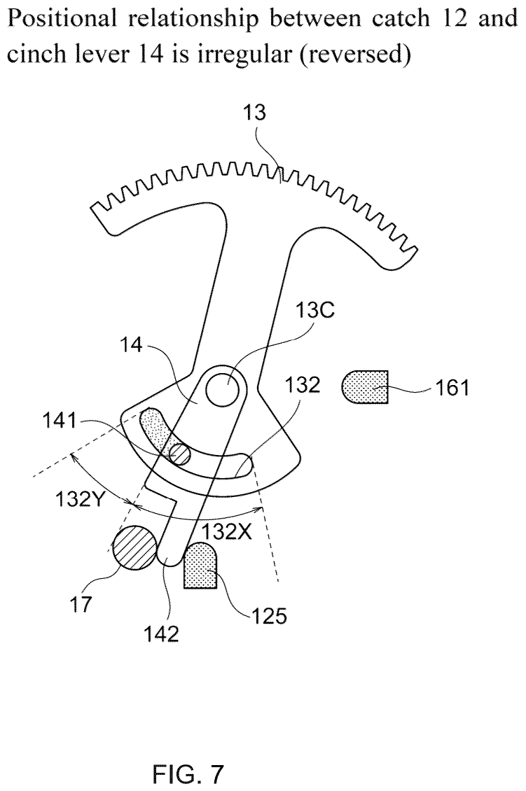

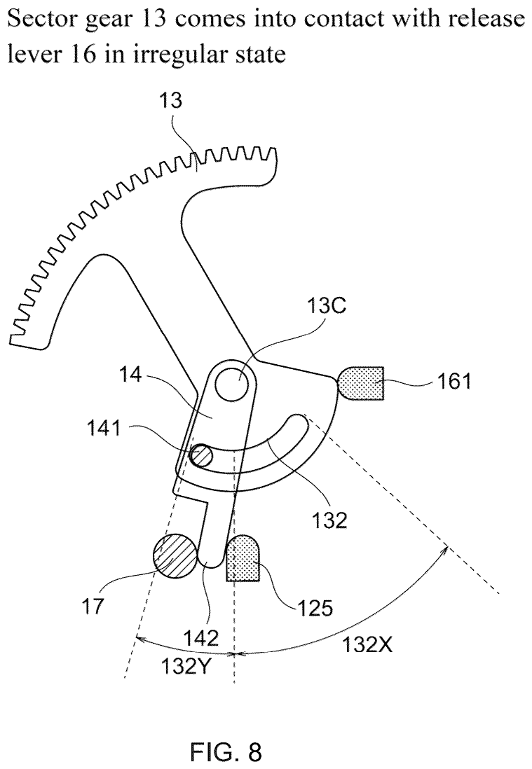

The description will now be directed to a phenomenon that the positional relationship between the catch 12 and the cinch lever 14 becomes an irregular state in the latch device 1 of the present embodiment described above. FIG. 6 is a set of perspective views of the latch device for explaining the cause of an irregular positional relationship between the catch 12 and the cinch lever 14, FIG. 7 is an enlarged front view of the sector gear 13, cinch lever 14, and catch 12 illustrated in the right diagram of FIG. 6, and FIG. 8 is a front view illustrating the operation of returning from the irregular positional relationship illustrated in FIG. 7.

The inventors have confirmed that, in the door closing operation illustrated in FIG. 4, when the driver operates to close the door and the door is in the half-latched position P2, if the driver operates to open the door in the opposite direction and to return the catch 12 to the state before the half-latch, the contact portion 142 of the cinch lever 14, which is located behind the catch 12 in the half-latched position P2, will come to the front side of the catch 12. FIG. 6 is a perspective view illustrating this state.

The left diagram of FIG. 6 illustrates the half-latched state, and as the catch 12 rotates to the half-latched position P2, the sensor 4 detects this and the controller 5 starts to rotate the sector gear 13 in the latch direction (clockwise direction), but at this time, as illustrated in the center diagram, when the driver performs an operation to open the door, the striker 2 causes reverse rotation of the catch 12 in the release direction. During this operation, the relationship in a normal latch operation in which the contact portion 142 of the cinch lever 14 is located behind the contact portion 125 of the catch 12 in the latch direction of the catch 12 as illustrated in FIG. 3B becomes an irregular relationship in which, as illustrated in FIG. 7, the contact portion 142 of the cinch lever 14 is located forward of the contact portion 125 of the catch 12 in the latch direction of the catch 12. When such an irregular state occurs, a problem may arise in that the cinch lever 14 is mechanically locked and the return operation cannot be performed.

In the latch device 1 of the present embodiment, therefore, the following two measures are taken so that even if the irregular positional relationship illustrated in FIG. 7 occurs, the normal positional relationship can be recovered by performing the release operation. One is that the groove 132 of the sector gear 13 is provided with the second groove 132Y so that the sector gear 13 can rotate in the release direction when the driver presses the door open switch even in the irregular positional relationship illustrated in FIG. 7. In other words, the groove 132 of the sector gear 13 is composed of the first groove 132X that functions when the catch 12 and the cinch lever 14 are in a normal positional relationship and the second groove 132Y that functions during the return operation when the catch 12 and the cinch lever 14 are in an irregular positional relationship.

That is, in the irregular positional relationship illustrated in FIG. 7, the catch 12 rotates to the fully-latched position P3 and is restrained by the pawl 15, or the catch 12 remains in the half-latched position P2 and is temporarily restrained by the pawl 15, but in either case, the rotation of the catch 12 is restricted by the pawl 15. It is therefore necessary to rotate the sector gear 13 in the release direction (clockwise direction) to rotate the release lever 16 in the release direction, thereby rotating the pawl 15 in the release direction.

In the latch device 1 of the present embodiment, even when the cinch lever 14 cannot rotate due to the irregular positional relationship illustrated in FIG. 7, by rotating the sector gear 13 in the release direction (clockwise direction) as illustrated in FIG. 8, the pin 141 of the cinch lever 14 slides on the second groove 132Y in the groove 132 of the sector gear 13, so that the sector gear 13 can push the first contact portion 161 of the release lever 16. This allows the catch 12 to return to the unlatched position P1 due to the elastic bias, and the cinch lever 14 also rotates counterclockwise due to the elastic bias and can return to its original position. When the door close operation is performed again from this state, the cinching operation is performed in the normal positional relationship. If the groove 132 of the sector gear 13 is not provided with the second groove 132Y, the pin 141 of the cinch lever 14 will stop at the left end of the first groove 132X, and the sector gear 13 cannot rotate further in the release direction.

The second measure taken to enable the normal positional relationship to be recovered by performing the release operation even if the irregular positional relationship illustrated in FIG. 7 occurs is to provide the base plate 11 with a stopper 17 as illustrated in FIG. 1. As described above, when the half-latched position P2 of the catch 12 is detected by the sensor 4, a warning display that the door is half-shut is displayed to alert the driver. Accordingly, if the half-shut door display is not turned off even after the door closing operation, the driver will assume that some kind of abnormality occurs and will open the door again and perform the tightening operation.

However, when the positional relationship between the cinch lever 14 and the catch 12 is reversed and an irregular state occurs as illustrated in FIG. 7, if the catch 12 does not output a detection signal for the half-latched position P2, the system on the vehicle side including the controller 5 will determine that the door is in a fully-latched state, and the driver therefore may not notice the irregular state. Accordingly, in the latch device 1 of the present embodiment, the base plate 11 is provided with the stopper 17, and as illustrated in FIG. 7, when the contact portion 142 of the cinch lever 14 is located forward of the contact portion 125 of the catch 12 in the latch direction of the catch 12, the rotation of the cinch lever 14 in the latch direction is restricted so as to prevent the catch 12 from reaching the fully-latch position P3. By providing this stopper 17, the rotation of the contact portion 125 of the catch 12 in the latch direction is restricted, so that the half-latched position P2 is maintained and the driver can be presented with a warning display of the half-shut door.

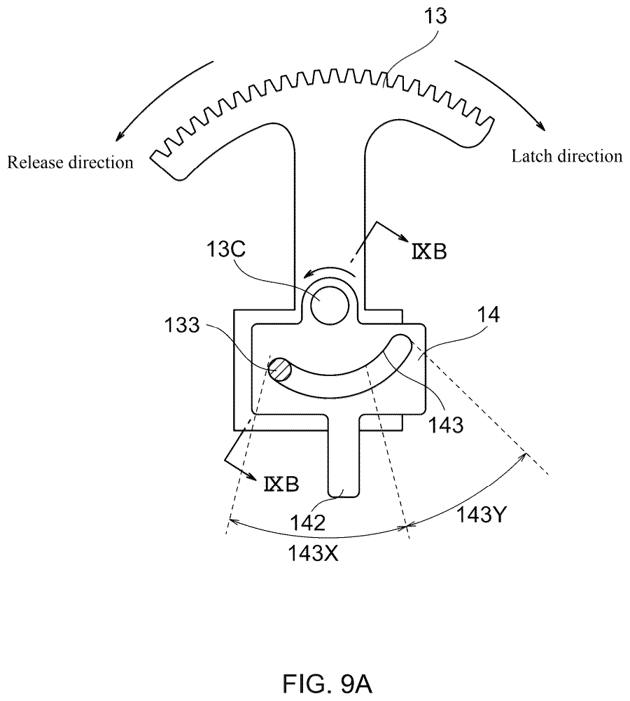

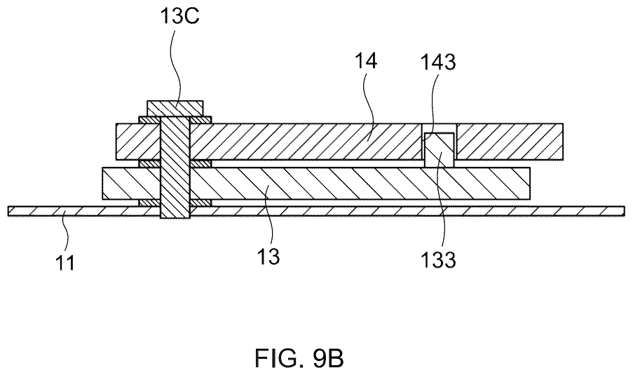

In the above-described embodiment, the rotation restricting section is represented by the groove 132 formed in the sector gear 13 and the pin 141 provided on the cinch lever 14, but a pin may be provided on the sector gear 13 and a groove may be formed in the cinch lever 14. FIG. 9A is a front view illustrating the sector gear 13 and cinch lever 14 of another embodiment of the latch device 1 for a vehicle door according to the present invention, and FIG. 9B is a cross-sectional view taken along line IXB-IXB of FIG. 9A. In the embodiment illustrated in FIGS. 9A and 9B, the cinch lever 14 is provided with a groove 143 and the sector gear 13 is provided with a pin 133 that engages with the groove 143, so the first groove 132X in the above-described embodiment corresponds to a first groove 143X located on the left side of the groove 143 in the present embodiment, and the second groove 132Y in the above-described embodiment corresponds to a second groove 143Y located on the right side of the groove 143 in the present embodiment. The groove 143 and pin 133 in the present embodiment are an example of the rotation restricting section according to the present invention.

As described above, the latch device 1 for a vehicle door of the present embodiment is provided on the door side of a vehicle. The latch device 1 includes the catch 12 that is provided to be elastically biased in the release direction toward the unlatched position so that the catch 12 can rotate in the latch direction toward the fully-latched position and in the release direction. The catch 12 engages with the striker 2 provided on the body side of the vehicle. The latch device 1 further includes the sector gear 13 that is rotated by the actuator 3, the cinch lever 14 that is coupled to the sector gear 13 and that, as the sector gear 13 rotates, comes into contact with the contact portion 125 of the catch 12 on the rear side in the latch direction of the catch 12, thereby rotating the catch 12 in the latch direction, and the pawl 15 and release lever 16 that restrict rotation of the catch 12 in the release direction and are elastically biased in the restriction direction. The pawl 15 and the release lever 16 are rotatable in the counter-restriction direction against the elastic bias upon contact with the sector gear 13. One of the sector gear 13 and the cinch lever 14 has a rotation restricting section that restricts a rotation range of the sector gear 13 depending on the rotation position of the cinch lever 14. The rotation restricting section is configured such that when the catch 12 is in a position between the fully-latched position and the unlatched position and the cinch lever 14 is located forward of the contact portion 125 of the catch 12 in the latch direction of the catch 12, the sector gear 13 comes into contact with the release lever 16 to allow the release lever 16 to rotate in the counter-restriction direction. According to this configuration, even when the positional relationship between the catch 12 and the cinch lever 14 becomes the irregular state, the sector gear 13 comes into contact with the release lever 16 to allow the release lever 16 to rotate in the counter-restriction direction, so that the catch 12 can rotate in the release direction to return to the unlatched position P1. As a result, the catch 12 and the cinch lever 14 can recover the normal positional relationship.

Additionally or alternatively, the latch device 1 for a vehicle door of the present embodiment further includes the stopper 17 that, when the cinch lever 14 is located forward of the contact portion 125 of the catch 12 in the latch direction of the catch 12, restricts rotation of the cinch lever 14 in the latch direction to prevent the catch 12 from reaching the fully-latched position. Thus, even when the positional relationship between the catch 12 and the cinch lever 14 becomes an irregular state, rotation of the contact portion 125 of the catch 12 in the latch direction is restricted by the stopper 17 via the cinch lever 14. This allows the catch 12 to maintain the half-latched position P2, and the driver can therefore be presented with a warning display of the half-shut door.

Additionally or alternatively, in the latch device 1 for a vehicle door of the present embodiment, the rotation restricting section is a groove 132, 143 with which the pin 141, 133 provided on the other of the sector gear 13 and the cinch lever 14 engages, and the groove 132, 143 is shaped such that when the catch 12 is in a position between the fully-latched position P3 and the unlatched position P1 and the cinch lever 14 is located forward of the contact portion 125 of the catch 12 in the latch direction of the catch 12, the pin 141, 133 can move through the groove 132, 143 to a position at which the sector gear 13 comes into contact with the release lever 16. According to this configuration, even when the positional relationship between the catch 12 and the cinch lever 14 becomes the irregular state, the sector gear 13 comes into contact with the release lever 16 to allow the release lever 16 to rotate in the counter-restriction direction, so that the catch 12 can rotate in the release direction to return to the unlatched position P1. As a result, the catch 12 and the cinch lever 14 can recover the normal positional relationship.

Additionally or alternatively, in the latch device 1 for a vehicle door of the present embodiment, the groove 132, 143 includes a first groove 132X, 143X and a second groove 132Y 143Y, and the second groove 132Y 143Y is such that, provided that the catch 12 is in a position between the fully-latched position P3 and the unlatched position P1 and the cinch lever 14 is located forward of the contact portion 125 of the catch 12 in the latch direction of the catch 12, the pin 141, 133 moves while engaging with the second groove 132Y 143Y when the sector gear 13 rotates to a position at which it comes into contact with the release lever 16. According to this configuration, even when the positional relationship between the catch 12 and the cinch lever 14 becomes the irregular state, the sector gear 13 comes into contact with the release lever 16 to allow the release lever 16 to rotate in the counter-restriction direction, so that the catch 12 can rotate in the release direction to return to the unlatched position P1. As a result, the catch 12 and the cinch lever 14 can recover the normal positional relationship.

Additionally or alternatively, in the latch device 1 for a vehicle door of the present embodiment, the drive element includes a sector gear 13, the release member includes a pawl 15 and a release lever 16, the pawl 15 comes into contact with the catch 12 so as to restrict rotation of the catch 12 in the release direction and is elastically biased in the restriction direction, and the release lever 16 comes into contact with the pawl 15 upon contact with the sector gear 13 and rotates the pawl 15 in the counter-restriction direction against the elastic bias. According to this configuration, even when the positional relationship between the catch 12 and the cinch lever 14 becomes the irregular state, the sector gear 13 comes into contact with the release lever 16 to allow the release lever 16 to rotate in the counter-restriction direction, so that the catch 12 can rotate in the release direction to return to the unlatched position P1. As a result, the catch 12 and the cinch lever 14 can recover the normal positional relationship.

Additionally or alternatively, the latch device 1 for a vehicle door of the present embodiment further includes a base plate 11, wherein the catch 12, the sector gear 13, the cinch lever 14, the pawl 15, and the release lever 16 are each provided on the base plate 11 so as to be rotatable, the catch 12 is elastically biased in the release direction relative to the base plate 11, the sector gear 13 and the cinch lever 14 are supported on the base plate 11 via the same rotation shaft 13C, the cinch lever 14 is elastically biased in the release direction relative to the sector gear 13, the pawl 15 is elastically biased in the restriction direction relative to the base plate 11, and the release lever 16 is elastically biased relative to the base plate 11 in a direction that allows the pawl 15 to rotate in the restriction direction. According to this configuration, even when the positional relationship between the catch 12 and the cinch lever 14 becomes the irregular state, the sector gear 13 comes into contact with the release lever 16 to allow the release lever 16 to rotate in the counter-restriction direction, so that the catch 12 can rotate in the release direction to return to the unlatched position P1. As a result, the catch 12 and the cinch lever 14 can recover the normal positional relationship.

Additionally or alternatively, the latch device 1 for a vehicle door of the present embodiment further includes: a sensor 4 that detects a half-latched position P2 of the catch 12; and a controller 5 that drives and controls the actuator 3 based on a detection signal from the sensor 4 and a release signal from a door open switch, wherein the controller 5 operates to: when detecting that the catch 12 is in the half-latched position P2 by using the sensor 4, drive the sector gear 13 by the drive and control of the actuator 3 to rotate the cinch lever 14 in the latch direction and rotate the catch 12 to the fully-latched position P3; and when the release signal from the door open switch is input, drive the sector gear 13 by the drive and control of the actuator 3 to release restriction of the catch 12 by the pawl 15 and rotate the catch 12 to the half-latched position P2 or the unlatched position P1. According to this configuration, even when the positional relationship between the catch 12 and the cinch lever 14 becomes the irregular state, the sector gear 13 comes into contact with the release lever 16 to allow the release lever 16 to rotate in the counter-restriction direction, so that the catch 12 can rotate in the release direction to return to the unlatched position P1. As a result, the catch 12 and the cinch lever 14 can recover the normal positional relationship.

1. A vehicle door latch device provided on a door side of a vehicle, the vehicle door latch device comprising:
a catch that is provided to be elastically biased in a release direction toward an unlatched position so that the catch can rotate in a latch direction toward a fully-latched position and in the release direction, the catch engaging with a striker provided on a body side of the vehicle;
a drive element that is rotated by an actuator;
a cinch lever that is coupled to the drive element and that, as the drive element rotates, comes into contact with a contact portion of the catch on a rear side in the latch direction of the catch, thereby rotating the catch in the latch direction; and
a release member that restricts rotation of the catch in the release direction and is elastically biased in the restriction direction, the release member being rotatable in a counter-restriction direction against the elastic bias upon contact with the drive element,
one of the drive element and the cinch lever having a rotation restricting section that restricts a rotation range of the drive element depending on a rotation position of the cinch lever,
the rotation restricting section being such that when the catch is in a position between the fully-latched position and the unlatched position and the cinch lever is located forward of the contact portion of the catch in the latch direction of the catch, the drive element comes into contact with the release member to allow the release member to rotate in the counter-restriction direction.

2. The vehicle door latch device according to claim 1, further comprising
a stopper that, when the cinch lever is located forward of the contact portion of the catch in the latch direction of the catch, restricts rotation of the cinch lever in the latch direction to prevent the catch from reaching the fully-latched position.

3. The vehicle door latch device according to claim 1, wherein
the rotation restricting section is a groove with which a pin member provided on the other of the drive element and the cinch lever engages, and
the groove is shaped such that when the catch is in a position between the fully-latched position and the unlatched position and the cinch lever is located forward of the contact portion of the catch in the latch direction of the catch, the pin member can move through the groove to a position at which the drive element comes into contact with the release member.

4. The vehicle door latch device according to claim 3, wherein
the groove includes a first groove and a second groove, and
the second groove is such that, provided that the catch is in a position between the fully-latched position and the unlatched position and the cinch lever is located forward of the contact portion of the catch in the latch direction of the catch, the pin member moves while engaging with the second groove when the drive element rotates to a position at which it comes into contact with the release member.

5. The vehicle door latch device according to claim 1, wherein
the drive element includes a sector gear,
the release member includes a pawl and a release lever,
the pawl comes into contact with the catch so as to restrict rotation of the catch in the release direction and is elastically biased in the restriction direction, and
the release lever comes into contact with the pawl upon contact with the drive element and rotates the pawl in the counter-restriction direction against the elastic bias.

6. The vehicle door latch device according to claim 5, further comprising
a base plate, wherein
the catch, the drive element, the cinch lever, the pawl, and the release lever are each provided on the base plate so as to be rotatable,
the catch is elastically biased in the release direction relative to the base plate,
the drive element and the cinch lever are supported on the base plate via a same rotation shaft,
the cinch lever is elastically biased in the release direction relative to the drive element,
the pawl is elastically biased in the restriction direction relative to the base plate, and
the release lever is elastically biased relative to the base plate in a direction that allows the pawl to rotate in the restriction direction.

7. The vehicle door latch device according to claim 6, further comprising:
a sensor that detects a half-latched position of the catch; and
a controller that drives and controls the actuator based on a detection signal from the sensor and a release signal from a door open switch,
wherein the controller operates to:
when detecting that the catch is in the half-latched position by using the sensor, drive the drive element by the drive and control of the actuator to rotate the cinch lever in the latch direction and rotate the catch to the fully-latched position; and
when the release signal from the door open switch is input, drive the drive element by the drive and control of the actuator to release restriction of the catch by the pawl and rotate the catch to the half-latched position or the unlatched position.
